(19) United States
(12) Patent Application Publication
(10) Pub. No.: US 2004/0103237 A1
(43) Pub. Date: May 27, 2004

(54) Memory access generation with improved bandwidth performance

(76) Inventor: Satyajit Mohapatra, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/304,420

(22) Filed: Nov. 25, 2002

(51) Int. Cl. G06F 12/00

(52) U.S. Cl. 711/5; 711/202

(57) ABSTRACT

The claimed subject matter facilitates an address mapping of memory access requests.

### BACKGROUND

The present disclosure is related to memory controllers or processors with memory controller functionality, and more particularly, to generating memory access requests.

As is well known, a chipset, memory controller, and/or a processor supervise a memory interface in computers, networking, and wireless systems. Typically, a memory access is based at least in part on address and chip select signals. For example, a typical memory access comprises: selecting a dynamic random access memory (DRAM) chip; selecting a bank within the DRAM chip by precharging the bank; activating a row within the bank; and concluding with selection of a column within the row.

Typically, applications that utilize large, continuous portions of data utilize an open page operation to efficiently utilize access to the selected memory bank by bypassing the precharge operation (closing or releasing the sense amplifiers). The open page operation is efficient because it eliminates two portions of a typical memory access, selection of the DRAM chip and the precharge operation, by anticipating the next data access will be to the same bank.

In contrast, other applications, such as a network processor, access data in random fashion because the data is temporal (addresses are random) and smaller portions of data are accessed. An open page operation is not efficient for this application because of a possibility that the next access would be to a different row and the particular page needs to be closed and results in a reduction of bandwidth as the page is closed by a precharge command. Likewise, other timing constraints, such as, Row Cycle Time (T_{RC}) and row address strobe (RAS) Cycle Time (T_{RAS}), limit the ability to efficiently close a page and results in further degradation of bandwidth as the processor waits for the completion of the closing of the page.

An example of a typical memory access generation is depicted in a table of FIG. 1 for accessing two memory chips with eight memory banks. Typically, a memory chip is accessed based at least in part on a chip select and a bank select address. For example, the memory access requests are depicted in the plurality of rows labeled as 102. The column headers, 104 and 106, depicted the chip select and bank select address, respectively. The first eight memory access requests are for chip 0. In contrast, the last eight memory access requests are for chip 1. The first memory access request is for bank 0 of chip 0; the second memory access request is for bank 1 of chip 0, etc. This example illustrates an inefficient access of memory chips because the requests are in a sequential manner for each chip and bank and could result in timing violations for accessing sequential (adjacent) memory banks.

### BRIEF DESCRIPTION OF THE DRAWINGS

claimed subject matter is particularly and distinctly pointed out in the concluding portion of the specification. The claimed subject matter, however, both as to organization and method of operation, together with objects, features, and advantages thereof, may best be understood by reference to the following detailed description when read with the accompanying drawings in which:

FIG. 1 is a prior art table depicting memory access requests to a plurality of memory chips.

FIG. 2 is a schematic diagram illustrating an embodiment of a memory access generation in accordance with the claimed subject matter.

FIG. 3 is a table illustrating an embodiment of memory accesses in accordance with the claimed subject matter.

FIG. 4 is a table illustrating an embodiment of memory accesses in accordance with the claimed subject matter.

FIG. 5 is a block diagram illustrating a system in accordance with the claimed subject matter.

FIG. 6 is a flowchart illustrating an embodiment of a method in accordance with the claimed subject matter.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

An area of current technological development relates to efficiently generating memory access requests. As previously described, open page operations are not efficient for applications that have temporal access to memory or memories. Thus, the preceding type of application utilizes a closed page mode of operation. However, a need exists for an efficient closed page mode of operation in light of the previously described timing constraints, Row Cycle Time (T_{RC}) and row address strobe (RAS) Cycle Time (T_{RAS}).

The claimed subject matter describes various address mapping functions to transform a memory access request in such a manner to allow for efficient accesses to memory banks within memory chips. For example, in one embodiment, an address-mapping scheme of designating the lower significant bits of the address block to be addressed by the chip select and bank select addresses of the memory. Furthermore, the claimed subject matter supports an optional bit swapping for the address mapping function to distribute the memory access transactions among a plurality of memory banks within the memory chips. In one embodiment, the claimed subject matter facilitates the two preceding address-mapping schemes for a closed page mode of operation.

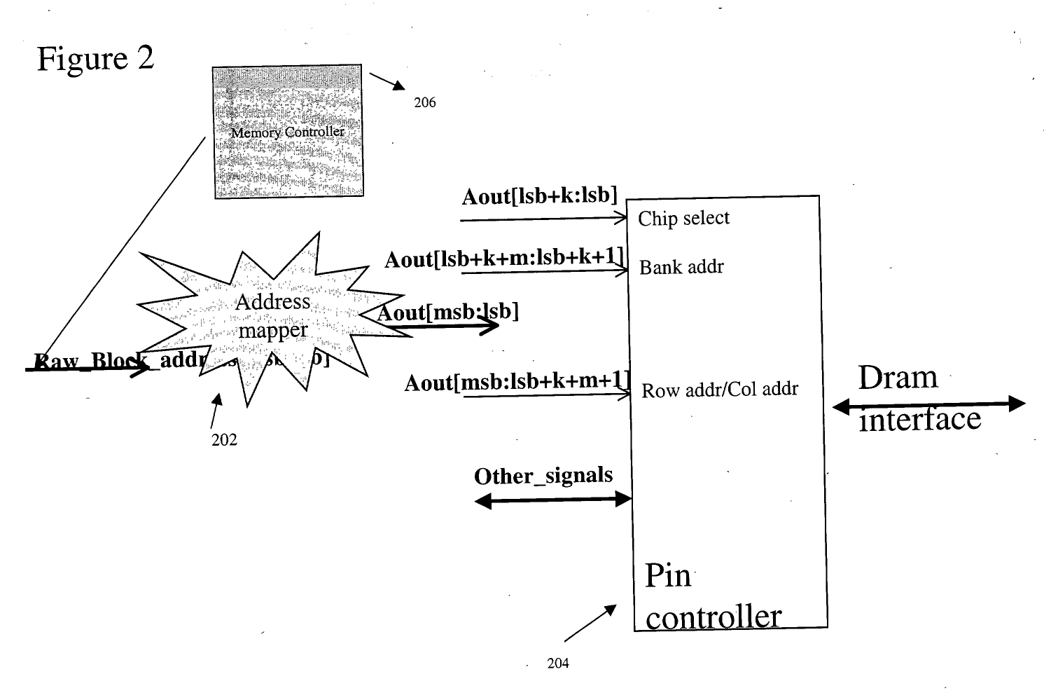

FIG. 2 is a schematic diagram illustrating an embodiment of a memory access generation in accordance with the claimed subject matter. The schematic comprises, but is not limited to, an address mapper 202, a pin controller 204, and a memory controller 206. In one embodiment, the pin controller may be coupled to a plurality of DRAM chips, such as, for example, the DRAM chips may be synchronous dynamic random access memory (SDRAM), double data rate (DDR), or any configuration of Rambus™ DRAMs (RDRAMs).

In one embodiment, the address mapper 202 is a logic circuit. Alternatively, in another embodiment, the address mapper 202 is accomplished by software instructions. Furthermore, the address mapper may be located in a memory controller or a chipset. Also, in another embodiment, the address mapper may be located in a network processor.

In one embodiment, the memory controller 206 may comprise more than one memory controller to support a variety of operations, such as, a channel mode of operation to a RDRAM via a channel. For example, in one embodiment, a network processor incorporates a single channel mode of operation to communicate to a RDRAM via a single channel. Likewise, the same network processor could support multiple channel modes of operation, such as, two channel and three-channel mode and incorporates the various address mapping logic as part of an application specific integrated circuit within the channel.

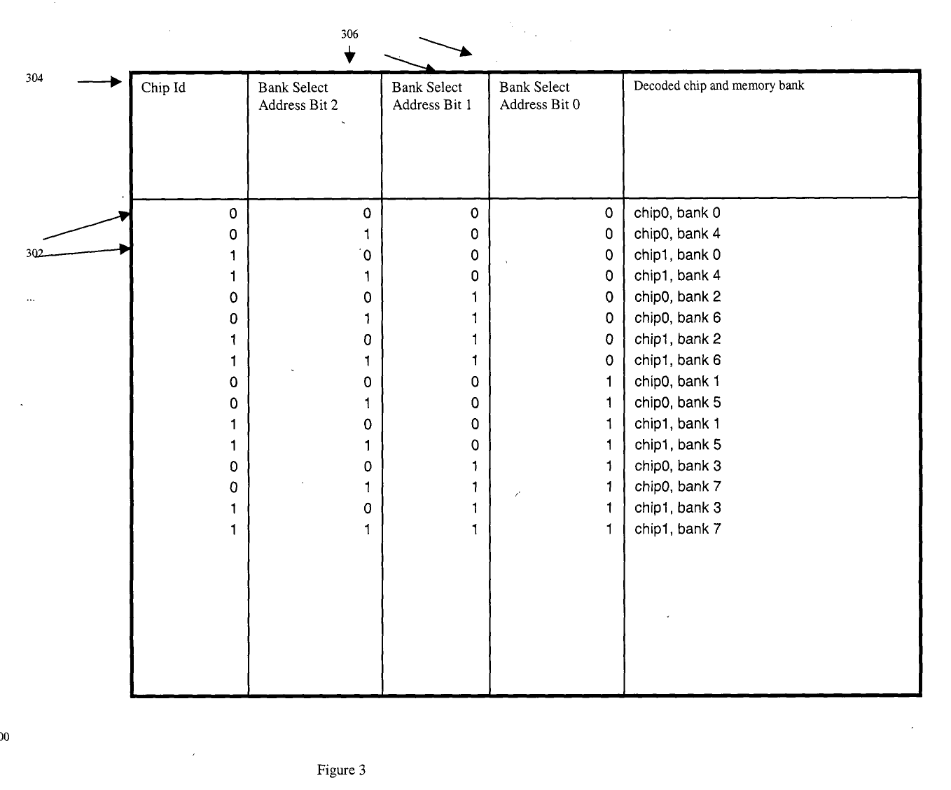

A memory controller 206 forwards a raw block address as part of a memory access request as an input to address mapper. In one embodiment, an output of the address mapper, Aout, is equivalent to the raw block address. Thus, Aout=Raw_block_address. However, a subset of the lower significant bits of a memory address block of a memory chip are moved to an address location defined by the chip select and bank select address lines of the memory chip, which will be further discussed in connection with the table depicted in FIG. 3.

Alternatively, in another embodiment, the address mapper generates a different output. For example, the address mapper may generate an output, Aout, that allows for bit swapping a subset of the least significant bits (LSB) of the memory address blocks to convert them to a subset of the most significant bits (MSB). In one embodiment, the subset is the lower (k+m) bits of the least significant bits. Alternatively, in another embodiment, the subset of LSB bits is defined as the k bits. Therefore, for the embodiment of (k+m) bits, the output is Aout[msb:lsb]=Raw_block_addr[lsb+k+m:lsb]. Furthermore, the Aout may also be illustrated in a verilog syntax, such that:

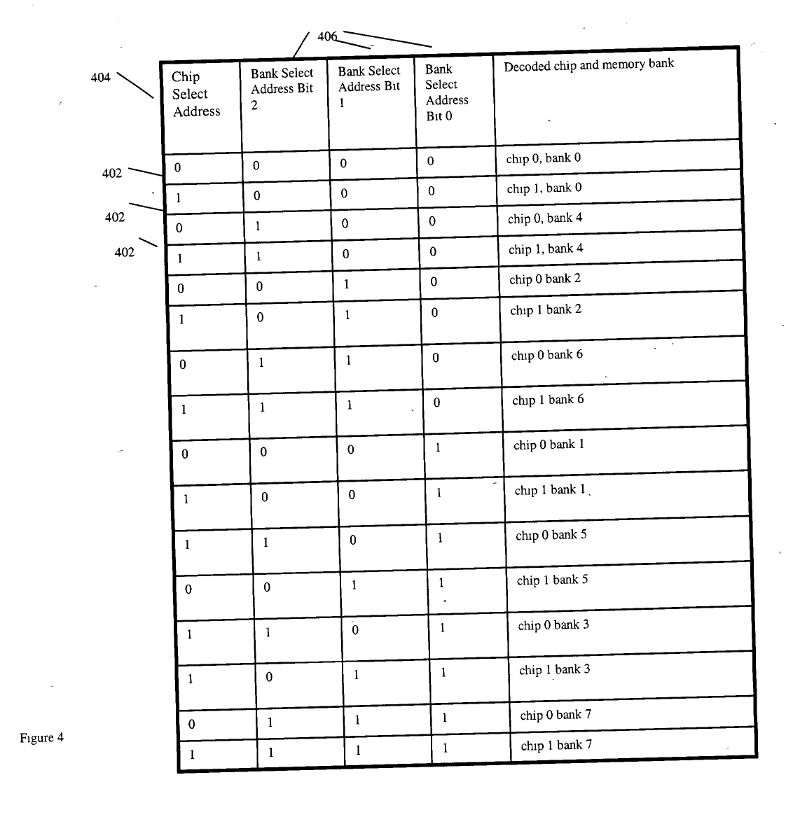

Aout[msb:lsb]=Raw_block_addr[msb:lsb+k+m+1]. An example of generating Aout for (k+m) bits will be further discussed in connection with the table depicted in FIG. 4.

The output address, Aout, is forwarded to the pin controller for both preceding embodiments of the output address. Likewise, various other non-address signals may be received by the pin controller, such as, power, timing signals, etc. . . . The pin controller generates memory access requests to a memory chip or chips based at least in part on the output address, Aout. As previously discussed, the generation of memory access requests will be discussed in connection with the tables of FIGS. 3 and 4.

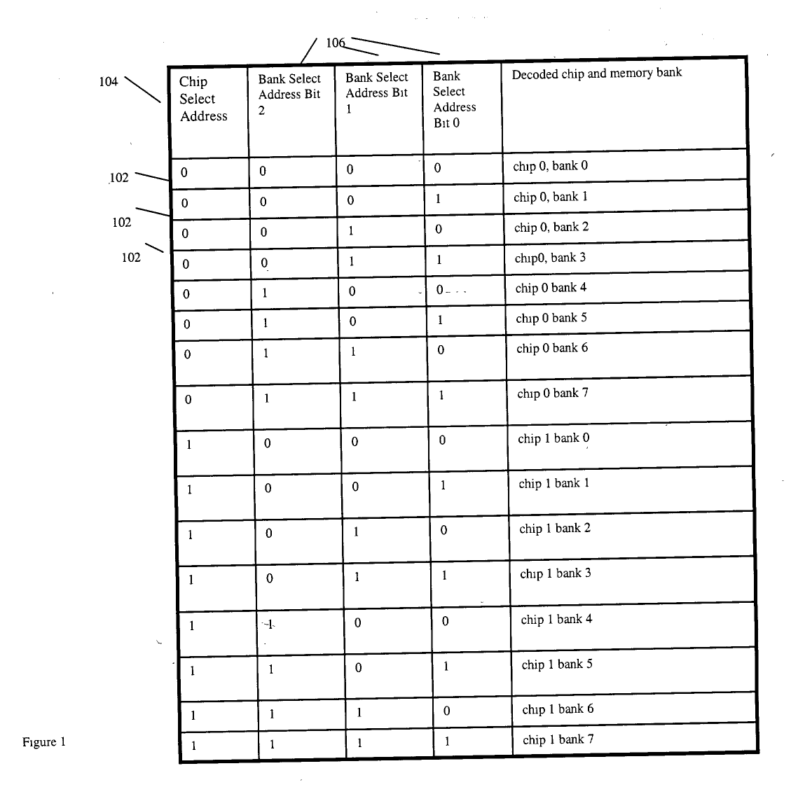

FIG. 3 is a table illustrating an embodiment for generating memory access requests in accordance with the claimed subject matter. In one embodiment, the table illustrates the output address, Aout, generated by the address mapper described earlier in connection with FIG. 2. In one embodiment, the table illustrates a transformation of a typical memory access request, such as, the requests depicted in connection with FIG. 1. For example, the second access request in FIG. 1 is “0001”b, and the claimed subject matter transforms the typical request to “0100”b by incorporating a subset of the lower significant bits of a memory address block of a memory chip that are moved to an address location referenced by the chip select and bank select address lines. This address mapping transformation is performed on all the memory access requests in FIG. 1 to produce the rows of memory access requests (402) of the table depicted in FIG. 4 based at least in part on the claimed subject matter.

For example, in one embodiment, the subset of LSB bits may be based at least in part on a size of a byte burst for a system. A byte burst is a continuous number of bytes that may be accessed in one access operation. Therefore, one example of defining the subset of LSB is as follows: 7 LSB bits for a 128 byte burst, 6 LSB bits for a 64 byte burst, 5 LSB bits for a 32 byte burst, 4 LSB bits for a 16 byte burst. Furthermore, the relationship is defined as 2^{LSB}=byte burst size.

As previously described, the memory controller 206 forwards a raw block address as part of a memory access request as an input to address mapper. The address mapper generates an output address, Aout, which is forwarded to the pin controller to facilitate an efficient generation of memory access requests to the memory chip or chips coupled to the pin controller.

The five columns in the FIG. 3 depict the output address, Aout. In one embodiment, FIG. 3 facilitates an address mapper to support moving a subset of the least significant bits (LSB) of the memory address blocks to convert them to a subset of the most significant bits (MSB). For example, the subset of LSB that are converted to the subset of MSB is (k) bits. In one embodiment, the k bits are defined such that “k” is based at least in part on the number of memory chips that are addressed by the apparatus depicted in connection with FIG. 2. For example, “k” may be defined as follows: k=0 for 2 chips, k=1 for 4 chips, k=2 for 8 chips, etc. Thus, the relationship may be defined as (2^{k+1}=number of memory chips).

One example to illustrate the efficiency of the memory access requests is for two memory chips with eight banks, respectively. Thus, k will have a value of zero and m has a value of three. The table illustrates a plurality of rows labeled as 302 and two column headers, 304 and 306, for an example of generating memory access requests to two memory chips with eight memory banks, respectively. In one embodiment, each row 302 illustrates a memory access request to a memory bank within a memory chip. Likewise, the column header 304 is the chip select address to select the particular memory chip and the three columns 306 are the bank select addresses to select a memory bank within the particular memory chip. The first memory access request has a binary value of “0000”b, which decodes to accessing bank 0 of memory chip 0. The next memory access request has a binary value of “0100”b, which decodes to accessing bank 4 of memory chip 0, and so on.

In contrast to the prior art depicted in connection with FIG. 1, the memory access requests in FIG. 3 exhibit an efficient access of the memory banks of the memory chips. For example, the memory access requests alternate between the banks in a non-sequential manner (bank 0, 4, 2, 6, 1, 5 etc. In contrast, the prior art memory access requests of FIG. 1 are in a sequential manner (bank 0, 1, 2, 3, etc). Therefore, the memory access requests are to non adjacent memory banks within a particular memory chip, as illustrated by access of bank 0, then bank 4, then bank 2, then bank 6, etc. Therefore, the timing constraint of one memory bank does not adversely impede the next memory access request. For example, a RDRAM has various timing constraints on access of adjacent memory banks.

The claimed subject matter depicted in FIG. 3 is not limited to an embodiment for generating accesses to two memory chips with eight memory banks. Rather, this embodiment was merely one example and the claimed subject matter supports multiple permutations of memory chips and memory banks. For example, the claimed subject matter supports generating accesses to four memory chips with eight memory banks by utilizing two bits for the chip select address and three bits for eight memory banks. Likewise, the claimed subject matter supports generating accesses to two memory chips with eight memory banks by utilizing three bits for the bank select address and retaining the use of one bit for the chip select address.

FIG. 4 is a table illustrating an embodiment of memory accesses in accordance with the claimed subject matter. In one embodiment, the table illustrates the output address, Aout, generated by the address mapper described earlier in connection with FIG. 2. The table in FIG. 4 illustrates a transformation of a typical memory access request, such as, the requests depicted in connection with FIG. 1. For example, the second access request in FIG. 1 is “0001”b, and the claimed subject matter transforms the typical request to “1000”b by incorporating swapping a subset of the least significant bits (LSB) of the memory address blocks to convert them to a subset of the most significant bits (MSB). This address mapping transformation is performed on all the memory access requests in FIG. 1 to produce the rows of memory access requests (402) of the table depicted in FIG. 4 based at least in part on the claimed subject matter.

As previously described, the memory controller 206 forwards a raw block address as part of a memory access request as an input to address mapper. The address mapper generates an output address, Aout, which is forwarded to the pin controller to facilitate an efficient generation of memory access requests to the memory chip or chips coupled to the pin controller.

The table illustrates a plurality of rows 402 and two column headers 404 and 406, for an embodiment of generating memory access requests to two memory chips with eight memory banks, respectively. In one embodiment, each row 402 illustrates a memory access request to a memory bank within a memory chip. Likewise, the column header 404 is the chip select address to select the particular memory chip and the three columns 406 are the bank select addresses to select a memory bank within the particular memory chip.

As previously discussed in FIG. 3, one embodiment for the address mapping is moving a subset of the least significant bits (LSB) of the memory address blocks to convert them to a subset of the most significant bits (MSB). In contrast, FIG. 4 depicts an address mapper that incorporates bit swapping a subset of the least significant bits (LSB) of the memory address blocks to convert them to a subset of the most significant bits (MSB). For example, the subset of LSB that are converted to the subset of MSB is (k+m) bits. In one embodiment, the (k+m) bits are defined such that “k” is based at least in part on the number of memory chips that are addressed by the apparatus depicted in connection with FIG. 2. For example, “k” may be defined as follows: k=0 for 2 chips, k=1 for 4 chips, k=2 for 8 chips, etc. Thus, the relationship may be defined as (2^{k+1}=number of external memory chips). Likewise, “m” is based at least in part on a number of memory banks within a memory chip. For example, 2^{m}=number of memory banks within a memory chip.

One example to illustrate the efficiency of the memory access requests is for two memory chips with eight banks, respectively. Thus, k will have a value of zero and m has a value of three. The first memory access request has a binary value of “0000”b, which decodes to accessing bank 0 of memory chip 0. The next memory access request has a binary value of “1000”b, which decodes to accessing bank 0 of memory chip 1. Continuing on, the next memory access request has a binary value of “0100”b, which decodes to accessing bank 4 of memory chip 0. The right hand column of the table explains the decoded bank and chip of the memory access request for clarifying the process of decoding the binary value.

In contrast to the prior art depicted in connection with FIG. 1, the memory access requests exhibit an efficient access of the memory banks of the memory chips. For example, the memory access requests alternate between memory chip 0 and memory chip 1. Therefore, the timing or functional constraints of one memory chip does not adversely impede the subsequent memory access. Furthermore, the memory access requests are to non adjacent memory banks within a particular memory chip, as illustrated by access of bank 0, then bank 4, then bank 2, then bank 6, etc. Therefore, the timing constraint of one memory bank does not adversely impede the next memory access request. For example, a RDRAM has various timing constraints on access of adjacent memory banks.

The claimed subject matter depicted in FIG. 4 is not limited to an embodiment for generating accesses to two memory chips with eight memory banks. Rather, this embodiment was merely one example and the claimed subject matter supports multiple permutations of memory chips and memory banks. For example, the claimed subject matter supports generating accesses to four memory chips with eight memory banks by utilizing two bits for the chip select address and retaining the use of three bits for eight memory banks. Likewise, the claimed subject matter supports generating accesses to two memory chips with eight memory banks by utilizing three bits for the bank select address and one bit for the chip select address.

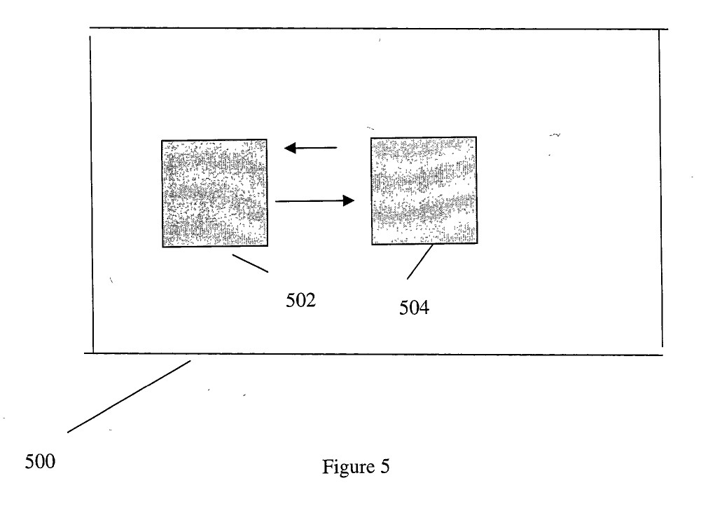

FIG. 5 is a block diagram illustrating a system that may employ the embodiment of FIGS. 2, 3, or 4, or all of them. The embodiment comprises a processor module 502 and a memory 504. System 500 may comprise, for example, a computing system, computer, personal digital assistant, internet tablet, communication device, or an integrated device, such as, a processor or chipset. In one embodiment, the system may incorporate memory controller functions within the processor module 502 or utilize a memory controller or chipset. In one embodiment, the processor module 502 is an Intel 1×P processor and the memory 504 is a plurality of RDRAMS. In another embodiment, the processor module 502 is an Intel 1×P processor and the memory 504 is a plurality of SDRAMS. Of course, the claimed subject matter is not limited to Intel IXP processors or RDRAMs and SDRAMs. For example, any processor may be implemented in this system to facilitate the memory access generation described in connection with the various embodiments of FIGS. 2, 3, 4, and 6.

Furthermore, in other embodiments, the processor module is a plurality of processors. For example, one embodiment for the system is a communication router with a variety of configurations for the processor. One configuration of the communication router is a single processor to operate as a duplex processor to perform both ingress and egress processing tasks. For example, an ingress task may be a classification, congestion avoidance, statistics, or segmentation scheduling, and an egress task may be a reassembly, congestion avoidance, or statistics. Another configuration is two processors, one processor is dedicated to egress tasks and the other processor is dedicated to ingress tasks. In yet another configuration of three processors, one processor is dedicated to egress tasks and the other two processors are dedicated to ingress tasks.

The processor or chipset generates a memory access request that is similar to the methods depicted in connection with FIG. 2 and/or 3. As previously described, the memory access requests are sent to the memory chip or chips based on either the address mapping function for the LSB bits or the bit swapping, or both.

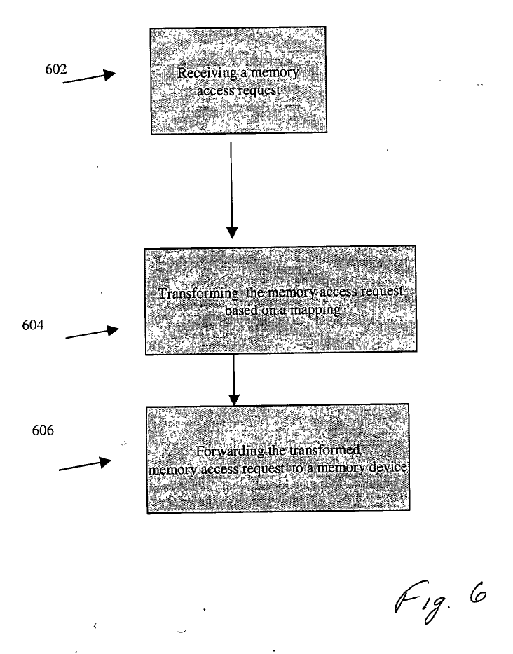

FIG. 6 is a flowchart illustrating an embodiment of a method in accordance with the claimed subject matter. In one embodiment, a typical memory address request is received, as illustrated in block 602. For example, the memory address is received by the address mapper from the memory controller depicted in FIG. 2. The memory access request is transformed based on an address mapping protocol, as illustrated in block 604. For example, a few different examples of address mapping protocols were described in connection with FIGS. 3 and 4. Eventually, in one embodiment, the transformed memory access request is forwarded to a memory device, via a pin controller in one embodiment, to perform a read and/or write operation. Of course, the claimed subject matter is not limited to this embodiment. A network processor may perform the address mapping and forward the transformed memory access request to a memory device or memory devices.

While certain features of the claimed subject matter have been illustrated and detailed herein, many modifications, substitutions, changes and equivalents will now occur to those skilled in the art. It is, therefore, to be understood that the appended claims are intended to cover all such modifications and changes as fall within the true spirit of the claimed subject matter.

1. A method for generating a memory access request comprising:
transforming the memory access request based at least in part on a mapping; and
forwarding the transformed memory access request to a memory device.

2. The method of claim 1 wherein the mapping comprises an address mapping based on designating the lower significant bits (LSB) of the memory address to be addressed by a chip select and bank select address of the memory device.

3. The method of claim 2 wherein designating the LSB bits is based at least in part on a byte burst size and a “k” number of memory devices, wherein k is an integer.

4. The method of claim 1 wherein the mapping comprises an address mapping based on bit swapping a subset of the least significant bits (LSB) of the memory address blocks to convert them to a subset of the most significant bits (MSB).

5 The method of claim 4 wherein bit swapping the subset of LSB bits is based on a byte burst size, a number of “m” memory banks within a memory device, and a “k” number of memory devices, wherein k and m are integers.

6. The method of claim 1 wherein the memory device is a DRAM.

7. The method of claim 1 wherein the memory device is a RDRAM.

8. An apparatus to generate a plurality of memory access requests to a memory device comprises:
an address mapper to generate the plurality of memory access requests to alternate access between a first and a second memory device; and
the apparatus to forward the plurality of memory access requests to the first and second memory device via a memory interface.

9. The apparatus of claim 8 wherein the address mapper is based on designating the lower significant bits (LSB) of the memory address to be addressed by a chip select and bank select address of the memory device to access non-adjacent memory banks of either the first and second memory device.

10. The apparatus of claim 8 wherein the address mapper is based on bit swapping a subset of the least significant bits (LSB) of the memory address blocks to convert them to a subset of the most significant bits (MSB) to access non-adjacent memory banks of either the first and second memory device.

11. The apparatus of claim 8 wherein the memory device is a dynamic random access memory (DRAM).

12. The apparatus of claim 8 wherein the memory device is a Rambus dynamic random access memory (RDRAM).

13. The apparatus of claim 12 wherein the apparatus is to support a channel mode of operation with the RDRAM.

14. The apparatus of claim 8 wherein the apparatus is a network processor.

15. An apparatus to generate a plurality of memory access requests comprises:
an address mapper to generate the plurality of memory access requests for non-sequential memory banks of a first and second memory device; and
the apparatus to forward the plurality of memory access requests to the first and second memory device via a memory interface.

16. The apparatus of claim 15 wherein the address mapper is based on designating the lower significant bits (LSB) of the memory address to be addressed by a chip select and bank select address of the memory device.

17. The apparatus of claim 15 wherein the address mapper is based on bit swapping a subset of the least significant bits (LSB) of the memory address blocks to convert them to a subset of the most significant bits (MSB).

18. The apparatus of claim 15 wherein the memory device is a dynamic random access memory (DRAM).

19. The apparatus of claim 15 wherein the memory device is a Rambus dynamic random access memory (RDRAM).

20. The apparatus of claim 19 wherein the apparatus is to support a channel mode of operation with the RDRAM.

21. The apparatus of claim 15 wherein the apparatus is a network processor.

22. A system comprising:
at least one processor; and
an address mapper to generate the plurality of memory access requests to non-sequential memory banks of at least one memory device that is coupled to the system.

23. The system of claim 22 wherein the system comprises at least one of an integrated device, a computer system, a computing system, a personal digital assistant, and a communication device.

24. The system of claim 22 wherein the address mapper is based on designating the lower significant bits (LSB) of the memory address to be addressed by a chip select and bank select address of the memory device.

25. The system of claim 22 wherein the address mapper is based on bit swapping a subset of the least significant bits (LSB) of the memory address blocks to convert them to a subset of the most significant bits (MSB).

26. The system of claim 22 wherein the memory device is a dynamic random access memory (DRAM).

27. The system of claim 22 wherein the memory device is a Rambus dynamic random access memory (RDRAM).

28. The system of claim 23 wherein the communication device is a communication router to support at least one of the following modes: a single processor to operate as a duplex processor to perform both ingress and egress processing tasks; two processors, one processor is dedicated to egress tasks and the other processor is dedicated to ingress tasks; three processors, one processor is dedicated to egress tasks and the other two processors are dedicated to ingress tasks.

29. The system of claim 28 wherein the ingress task is at least one of a: classification, congestion avoidance, statistics, or segmentation scheduling.

30. The system of claim 28 wherein the egress task is at least one of a: reassembly, congestion avoidance, or statistics.
